(19) United States
(12) Patent Application Publication
(10) Pub. No.: US 2005/0076005 A1
(43) Pub. Date: Apr. 7, 2005

(54) Method and apparatus to associate data files with tasks or events

(75) Inventors: Thomas E. Chefalas, Somers, NY (US); Steven J. Mastrianni, Unionville, CT (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/662,789

(22) Filed: Sep. 15, 2003

(51) Int. Cl. G06F 7/00; G06F 17/30

(52) U.S. Cl. 707/2; 707/1

(57) ABSTRACT

A method, apparatus, and computer instructions for locating files. An input is received indicating that a file is to be saved. The file is saved in association with a unique identifier in a data store. The data store describes associations between files and unique identifiers, and files are retrieved based on unique identifiers in response to receiving the input.

### CROSS REFERENCE TO RELATED APPLICATIONS

The present invention is related to Method and Apparatus for the Automatic Discovery of the Relationships Between Applications and Their Associated Data and Configuration Files, Ser. No. 09/865,243, filed May 25, 2001, and Method and Apparatus for the Automatic Migration of Applications and Their Associated Data and Configuration Files, Ser. No. 09/865,249, filed May 25, 2001, and Method and Apparatus for Performing the Identification of Files to be Backed Up Using Relational Meta Data, Ser. No. 09/866,251, filed May 25, 2001, assigned to the same assignee, and incorporated herein by reference.

### BACKGROUND OF THE INVENTION

1. Technical Field

The present invention relates generally to an improved data processing system and in particular to a method and apparatus for managing information about files. Still more particularly, the present invention provides a method, apparatus, and computer instructions for managing files using tasks or events associated with the files.

2. Description of Related Art

A file system is used for storing and retrieving files from a storage device in a data processing system. A file system defines the directory structure for keeping track of files and meta data required to access those files. Further, a file system also defines the way files are named as well as the size of a file or volume. Currently available file systems use a hierarchical model of directories or folders. A hierarchical file system is a file organization method that stores data in a top-to-bottom organization structure. Accesses to data in type of file system starts at the top and proceeds downward through the different levels of hierarchy. For example, in Windows XP, the top of the hierarchy is a drive loader, such as “C:” or “D:”, followed by folders and subfolders. This type of system allows users to place files containing data, graphics, and documents inside a particular folder to provide easy access to these files. Users often place all the files having to do with a particular event or customer in a folder with the event or customer name used as the name of the folder. This type of placement and folder naming allows the user to locate files associated with that event or customer by reading the directory name and associating it with that event or customer. With the introduction of larger disk drives and increased number of data for events or customers, it has become increasingly difficult to locate files associated with a particular customer or event. Further, this type of organization of files fails to allow a user to identify files that are for a particular event or customer in the case in which those files are placed in an incorrect directory.

Therefore, it would be advantageous to have an improved method, apparatus, and computer instructions for associating data files with tasks or events.

### SUMMARY OF THE INVENTION

The present invention provides a method, apparatus, and computer instructions for locating files. An input is received indicating that a file is to be saved. The file is saved in association with a unique identifier in a data store. The data store describes associations between files and unique identifiers, and files are retrieved based on unique identifiers in response to receiving the input.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components involved in associating data files with tasks or events in accordance with a preferred embodiment of the present invention;

FIG. 4 is a diagram illustrating a presentation of file information to a user in accordance with a preferred embodiment of the present invention;

FIG. 5 is a diagram of meta data describing relationships between unique identifiers and associated data in accordance with a preferred embodiment of the present invention;

FIG. 6 is a diagram illustrating an example call in accordance with a preferred embodiment of the present invention;

FIG. 7 is a flowchart of a process used for installing the processes for automatically discovering relationships between applications and associated data in accordance with a preferred embodiment of the present invention;

FIG. 8 is a flowchart of a process used for handling requests for file operations in accordance with a preferred embodiment of the present invention;

FIG. 9 is a flowchart of a process used for processing an open operation in accordance with a preferred embodiment of the present invention;

FIG. 10 is a flowchart of a process used for processing a delete operation in accordance with a preferred embodiment of the present invention;

FIG. 11 is a flowchart of a process used for renaming in accordance with a preferred embodiment of the present invention;

FIG. 12 is a flowchart of a process used for processing a close or copy operation in accordance with a preferred embodiment of the present invention;

FIG. 13 is a flowchart of a process used for processing queries for file information in accordance with a preferred embodiment of the present invention; and

FIG. 14 is a flowchart of a process used to obtain a list of files in accordance with a preferred embodiment of the present invention.

### DETAILED DESCRIPTION

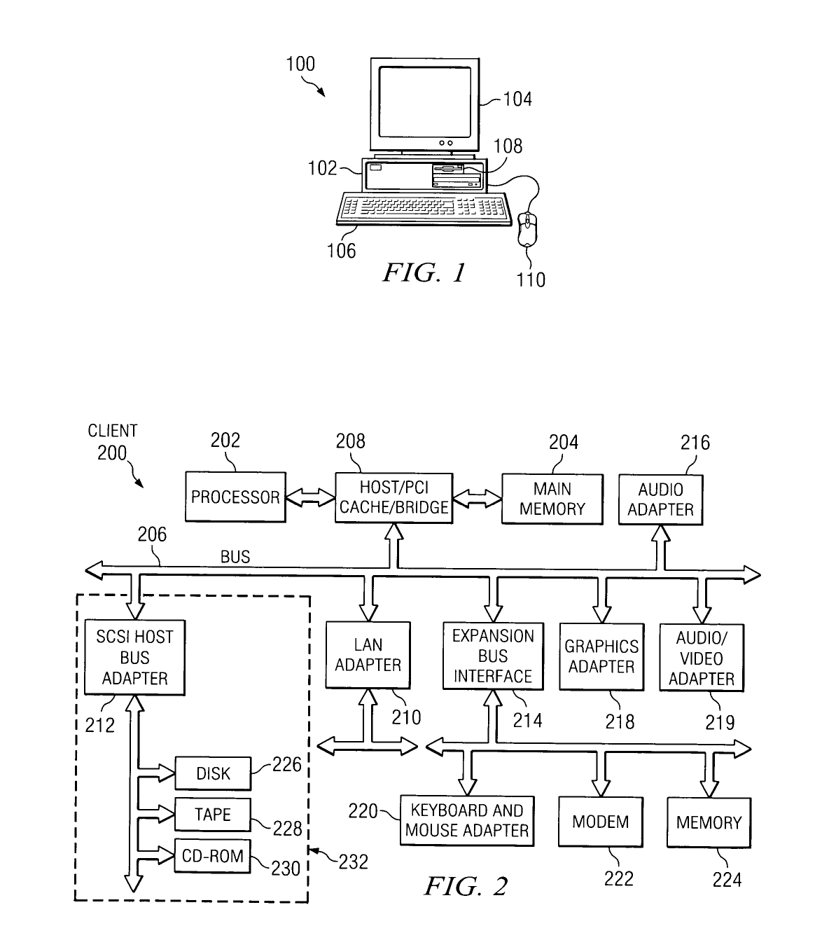

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

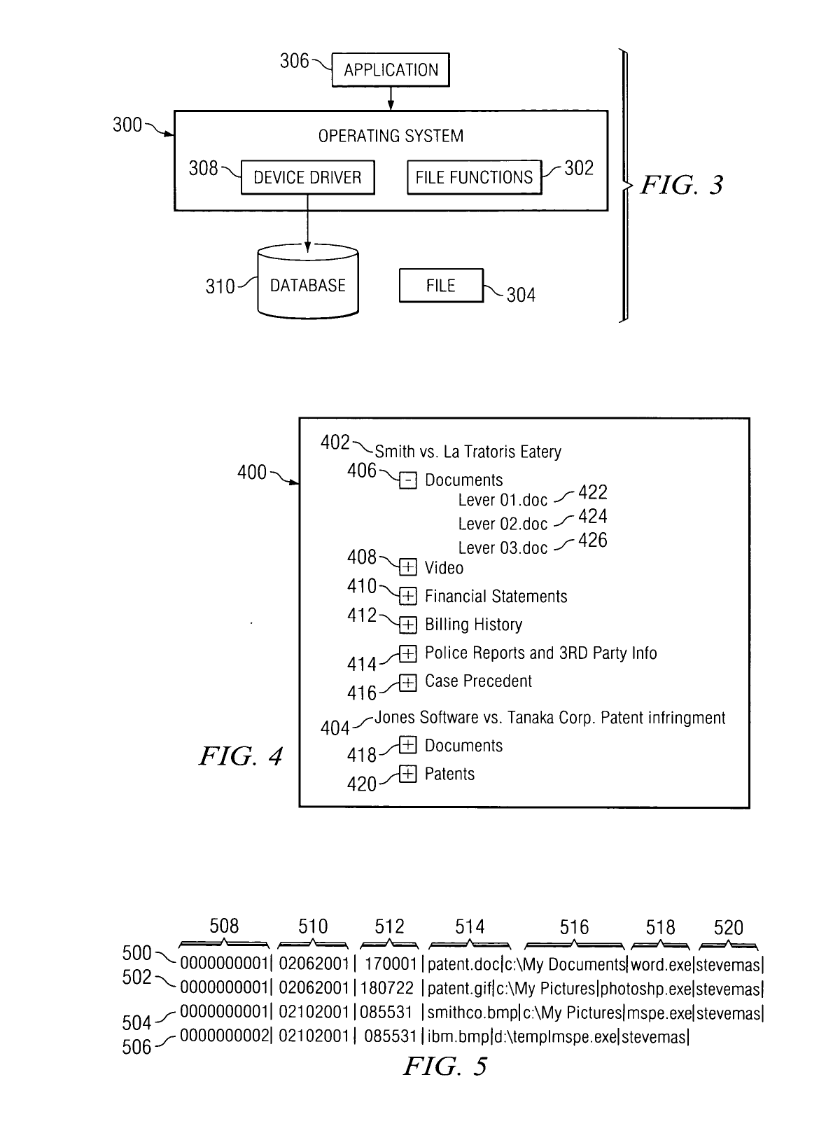

With reference next to FIG. 3, a diagram illustrating components involved in associating data files with tasks or events is depicted in accordance with a preferred embodiment of the present invention. The components illustrated in FIG. 3 may be implemented as software and data structures in a data processing system, such as data processing system 200 in FIG. 2.

The present invention provides an improved method, apparatus, and computer instructions for associating tasks and events with data files. In the depicted examples, the mechanism of the present invention, in the illustrative embodiments, includes a software device driver mechanism that is installed on the computer system at the time the operating system is installed. Software program “hooks” are used to connect to the operating system at a single point where all file-oriented requests are handled. This single point of entry for various classes of operating systems services is a standard feature of all currently available operating systems. When any executing program makes an open, close, delete, rename, or move file request, this request is detected along with any identifier used for a particular item that is associated with the file. As used herein, an item may be, for example, an event, a task, a person, a name of a company, a name of a lawsuit, or even a user name. The names for these items or a unique identifier may be used in associating files with the items. The relationship between the file and the item is captured and represented in a relational meta data format. As illustrated, an item is assigned a unique identifier. For example, ABC Company is an item that may be associated with a numerical identifier, such as 0000000001. This identifier is only used to identify the item ABC Company. Alternatively, the name “ABC Company” may form the unique identifier.

In these examples, this identifier is typically entered by a user. Alternatively, a program or application may generate identifiers for various items, such as, for example, tasks or events. Further, these relations may be generated between a particular user and a set of files. Additional meta data about the file creation also may be captured, such as the location of the file, time, date, or identity of the user. This relational meta data may be stored in another data file in the file system or saved in a database. This database may be protected and hidden from users to prevent deletion or corruption of data.

In the depicted examples, operating system 300 includes file functions 302. These file functions are used to perform different functions on files, such as file 304 in response to requests from applications, such as application 306. These functions include, for example, opening, closing, creating, copying, renaming, and deleting files. When the user starts application 306, application 306 generally requires a data file to act upon. For instance, starting a word processor usually requires that the user indicate the name of the file to be created, edited or processed. Most applications have some type of open menu where the user specifies which file they are going to work on. The user generally clicks a “file open” button or menu item to open a file, and is then presented with a list of files meeting that criteria to work on.

Using current technology, the list of files available to work on is determined by the file type, which may be identified through the file type extension. When an application is installed, it usually notifies the operating system of which file type extension should be associated with that program. For example, Microsoft Word notifies the operating system that it will use files with the .doc extension. After the application is installed, if the user selects a file with the .doc extension, the Microsoft Word application will be launched to operate on that file. Using current technology, the association between the application program and the file type extension exists until that application program is removed from the system. When the application is removed, the removal program also removes any associations that had been established at the time the application was installed.

With the mechanism of the present invention, files may be associated to items, not just extensions. Calls by application 306 to file functions 302 are hooked or routed to device driver 308. These function calls include opening, closing, creating, copying, renaming, and deleting a file. Each time a call for one of the file functions is made, the call is intercepted by device driver 308. The item is identified by device driver/service 308 along with the name of the data file being operated on. In the depicted examples, this item may be entered by the user through a graphical user interface provided by application 306. Alternatively, the unique identifiers for items may be automatically generated by application 306 without requiring user input.

For example, device driver 308 hooks the single entry point of the “file close” function. Each time a file, such as file 304, is closed, the close is intercepted by device driver 308. This device driver identifies the name of application 306 closing file 304, along with the name of file 304. In this example, file 304 is opened and closed by application 306, representing a normal close of file 304. The relational meta data that represents the association of file 304 to application 306 is updated in database 310 with the new information. If application 306 opens file 304, but another software entity, such as operating system 300 closes file 304, then an abnormal close may have occurred because of a failure in application 306.

Each time a file is opened or closed, the relational meta data for the given file is updated by device driver 308. The mechanism of the present invention also may hook the operating system entry points for file erase, file rename, file move, and file copy functions at the device driver level or at the operating system service level. These additional hooks also update the relational meta data in database 310. If an application program, in the process of executing, creates a file, the file creation information and an association between the item and the file are stored in relational meta data. If the application program deletes a file, the relational meta data for the deleted file is deleted. The relational meta data for file 304 is updated in database 310 and is updated if the application renames file 304. It is important to note that, in these examples, in the event that the same file is accessed by more than one program, the database also will contain the reference to the application that accessed the file most recently.

If the user copies file 304 to another location, the relational meta data for file 304 is updated with the new location. Further, a file may be associated with multiple items. For example, a letter may be associated with more than one unique identifier such that the letter may be accessed through each of those identifiers. In this situation, the relational meta data for file 304 is updated to reflect the association to multiple items or unique identifiers. In these examples, the unique identifier is a numeric representation of the logical grouping of files. This identifier is used in the database file and a set of tasks, events, or files are associated with a particular identifier in the database.

The identifier 1001103, for example, might be a unique identifier for “The Smith Case”. As a result, all documents, files, tasks, and events that appear in the database will be associated with the unique identifier. In the illustrative example, identifiers, such as, for example, “The Smith Case” and 1001103 are logically the same identifier. As a result, either or both identifiers may be used. As illustrated, “The Smith Case” may be entered or selected by the user with this identifier being translated to 1001103 for internal use within the database. Alternatively, the identifier “The Smith Case” may be used directly by the database. The database meta data contains a table of identifiers and their corresponding tasks, events, files, and documents. A database query can use the identifier or the event or task name as a key.

When the application 306 is started, the user is presented with a list of files to work on, depending on the file type extension registered with the operating system by application 306. The user selects one or more files to work on, and then confirms the choice by clicking an “OK” button or similar type of control. Some application programs, such as Microsoft Word, keep a finite length list of the files acted upon in persistent storage. The mechanism of the present invention provides a method, apparatus, and computer implemented instructions for a convenient way to provide quick access to files associated with an item such as, for example, an event, a task, a company, or a person.

The list of files displayed that can be acted upon is based on the file type extension. However, the user may have renamed the file with a different extension, or moved the file to another area on the disk or even another computer or network share. Application 304 has no direct knowledge of these files, their new extension, or their new location because the file type extension has changed or the files have been moved to an unknown location. Because this information is in database 310, application 304 can query database 310 through calls to device driver 308 to find the file names and location of all of the data and configuration files associated with a particular item. Application 304 then uses the list of files from database 310 to present to the user at the time application 304 is run. Instead of choosing a data file of a certain file type extension and from a specified physical location on the disk, the user can now select any file associated with a particular item from any location on the disk. The access to database 310 may be provide through standard application programming interface (API) calls made to device driver 308 from application 304 or another application. Using the access methods provided by the invention the user can query the relational database with such queries as:

Show me the files created between Dec. 1, 2000 and Dec. 15, 2000 for ABC Company.

Show me the files created since Jan. 1, 2001 by the user stevemas. In these illustrative examples, “ABC Company” and “stevemas” are items. These names also may form the unique identifiers in database 310 or a unique identifier may be associated with these names. If numerical unique identifiers are preferred in database 310, then these numerical identifiers may be associated with the names of the items.

The association of items with files and file locations may extend to files created, stored, or moved on remote storage devices located on another computer system. The mechanism of the present invention may be installed as an integral part of operating system 300, such as within a kernel. Alternatively, the mechanism may be added as a patch or add-on component if added to operating system 300 after its installation.

With reference next to FIG. 4, a diagram illustrating a presentation of file information to a user is depicted in accordance with a preferred embodiment of the present invention. In this example, display 400 is an exemplary display of a result that may be presented to a user in response to a request for files associated with events or tasks. Category 402 and category 404 represent the event or task entered by a user when a user desires to see data for a particular item. In this example, the item is the name of a lawsuit. In response to requesting item 402, categories 406, 408, 410, 412, 414, and 416 are presented to the user. Each of these entries represent a subclasses of documents or other types of files. In these examples, the unique identifier refers to a list. This list may contain documents or files. Alternatively, the list may be of a type group, which points to a hierarchical list of associates documents, tasks, or events. In category 404, subcategory 418 and subcategory 420 are presented if the user requests item 404. In response to selecting the category or one of the subcategories, all of the documents in those categories or subcategories may then be opened using the application associated with the file.

As shown in FIG. 4, different subcategories may be expanded to show files within those subcategories. For example, subcategory 406 has been expanded to show documents 422, 424, and 426.

Turning now to FIG. 5, a diagram of meta data describing relationships between unique identifiers and associated data is depicted in accordance with a preferred embodiment of the present invention. The unique identifiers may be employed to associate files with particular tasks, events, or even users. In the depicted example, records 500, 502, 504 and 506 are examples of meta data, which may be stored in a database, such as database 310 in FIG. 3. As illustrated, record 500 includes sections 508, 510, 512, 514, 516, 518, and 520.

Section 508 is a unique identifier for a particular task or event. Further, in the illustrative examples, this unique identifier also may be used to uniquely identify a particular user or customer. In this illustration, numerical, unique identifiers are employed rather than using the names of the items. For example, records 500, 502 and 504 are associated with the item name “Smith vs. La Tratoris Eatery”, which is identified as category 402 in FIG. 4. Record 506 is associated with the item name “Jones Software vs. Tanak Corp. Patent infringement”, which is identified as category 404 in FIG. 4. In this manner, records 500, 502, and 504 are identified when the unique identifier 0000000001 is used in a query for category 402 in FIG. 4. Thus, various files of different types maybe associated with a single item and retrieved through the identification of that item using the mechanism of the present invention.

Section 510 identifies the date of the last file update. Section 512 indicates the last time the file was accessed in hours, minutes, and seconds. Next, section 514 identifies the name of the file, while section 516 identifies the location of the file. The name of the application used to manipulate the file is identified in section 518. Finally, the user is identified in section 520.

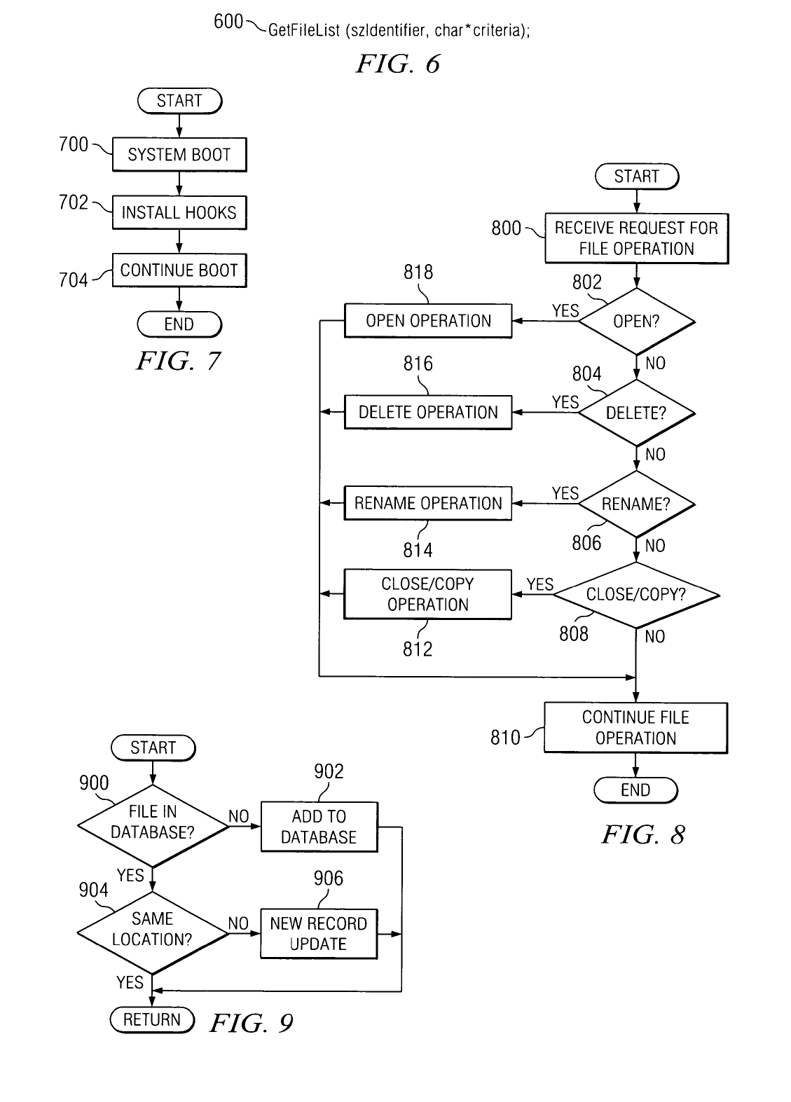

With reference now to FIG. 6, a diagram illustrating an example call is depicted in accordance with a preferred embodiment of the present invention. Call 600 is an example of a call, which may be used to obtain a file list. The call specifies an unique identifier as well as criteria, which may be used to search for records, such as records 500, 502, 504, and 506 in FIG. 5 within database 310 in FIG. 3. The criteria may be, for example, a list of files associated with the unique identifier 0000000001 that are more than 30 days old.

Turning next to FIG. 7, a flowchart of a process used for installing the processes for automatically discovering relationships between applications and associated data is depicted in accordance with a preferred embodiment of the present invention. The process begins by detecting a system boot of the data processing system (step 700). Next, hooks are installed (step 702). The hooks installed are those for use by a device driver, such as device driver 308 in FIG. 3, to hook or intercept calls for file functions. Then, the system boot is continued (step 704) with the process terminating thereafter.

The flowcharts illustrated in FIGS. 8-12 are examples of processes used to automatically store relationships between items and associated data. With reference now to FIG. 8, a flowchart of a process used for handling requests for file operations is depicted in accordance with a preferred embodiment of the present invention. The process illustrated in FIG. 8 may be implemented in a device driver, such as device driver 308 in FIG. 3.

The process begins by receiving a request for a file operation (step 800). Next, a determination is made as to whether the file operation is to open a file (step 802). If the file operation is not open, then a determination is made as to whether the file is to be deleted (step 804). If the file is not to be deleted, a determination is made as to whether the file is to be renamed (step 806).

If the file is not to be renamed, a determination is made as to whether the file is closed or copied (step 808). If the file is not to be closed or copied, file operation continues (step 810) with the process terminating thereafter. At this point, the file operation request is passed to the actual file function that is to process the request.

With reference again to step 808, if the file is to be closed or copied, close or copy operation is performed (step 812) with the process proceeding to step 810. Turning back to step 806, if the file is to be renamed, a rename operation is performed (step 814) with the process proceeding to step 810 thereafter. With reference again to step 804, if the file is to be deleted, a delete operation is performed (step 816) and the process proceeds to step 810 as described above. With reference again to step 802, if the file is opened, an open operation is performed (step 818) with the process proceeding to step 810.

Turning next to FIG. 9, a flowchart of a process used for processing an open operation is depicted in accordance with a preferred embodiment of the present invention. The process illustrated in FIG. 9 is a more detailed description of step 818 in FIG. 8.

This process is called in response to an open operation being present. The process begins with a determination as to whether a record of the file identified for the operation is present in the database (step 900). If the file is not present in the database, an identification of the file is added to the database (step 902) with the process returning thereafter for a continuation of the file operation. The identification may include, for example, a unique identifier, the name of the file, the name of application requesting the operation, a date, and a time of the request. The unique identifier is associated with an item and may take various forms, such as the name of the item or a unique number.

Otherwise, a determination is made as to whether the file is found in the same location (step 904). If the file is found at the same location, the process returns to continue processing the file operation. If the file is not in the same location, the record is updated with the new location (step 906) with the process then returning to continue processing of the file operation. The open operation occurs immediately because the database cannot be updated until it is known that the file can be opened.

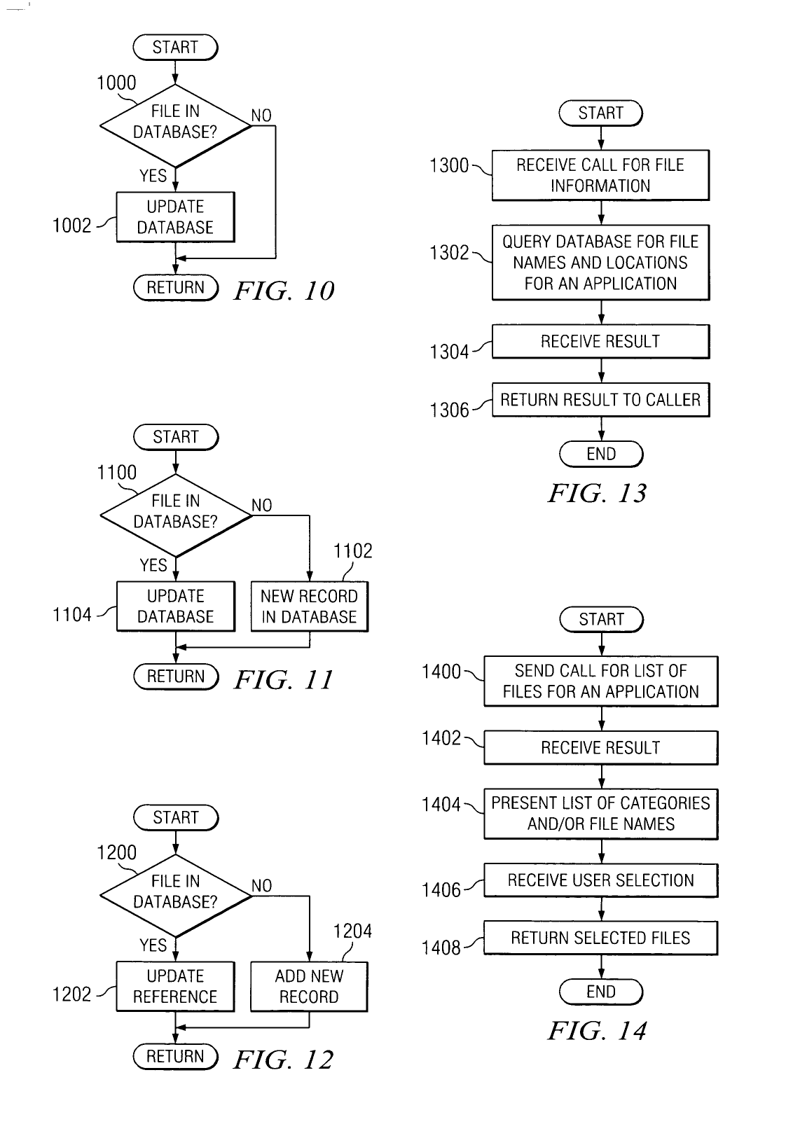

With reference now to FIG. 10, a flowchart of a process used for processing a delete operation is depicted in accordance with a preferred embodiment of the present invention. The process illustrated in FIG. 10 is a more detailed description of step 816 in FIG. 8.

The process begins with a determination as to whether a record of the file is in a database (step 1000). If the file is in the database, the database is updated (step 1002) with the process then returning to continue the file operation. This update reflects the application closing the file as well as other information, such as a time and date of the operation. Otherwise, the process returns without performing any action in the database. In this instance, the file is not tracked by the mechanism of the present invention.

Turning next to FIG. 11, a flowchart of a process used for renaming is depicted in accordance with a preferred embodiment of the present invention. The process illustrated in FIG. 11 is a more detailed description of step 814 in FIG. 8.

The process begins with a determination as to whether a record of the file is in the database (step 1100). If the file is not in the database, a new record is established in the database (step 1102), and the process returns to continue processing the file operation. The new record may be in a format, such as, for example, record 500 in FIG. 5. Otherwise, the database is updated (step 1104) with the process returning for continued processing of the file operation.

With reference now to FIG. 12, a flowchart of a process used for processing a close or copy operation is depicted in accordance with a preferred embodiment of the present invention. The process illustrated in FIG. 12 is a more detailed description of step 812 in FIG. 8.

The process begins with a determination as to whether a record of the file is in a database (step 1200). If the file is in the database, a reference is updated (step 1202) with the process returning to continue the file operation. Otherwise, a new record for the file is added to the database (step 1204), and the process returns for continuation of the file operation.

Turning next to FIG. 13, a flowchart of a process used for processing queries for file information is depicted in accordance with a preferred embodiment of the present invention. The process illustrated in FIG. 13 may be implemented in a device driver, such as device driver 308 in FIG. 3.

The process begins by receiving a call for file information (step 1300). This call may be received from an application, such as application 306 in FIG. 3. Next, a database is queried for file names and locations of files associated with a unique identifier identified in the query (step 1302). As mentioned before, this unique identifier may take various forms. For example, the name of the item may be used or a number may be associated with the item. A result is received from the database (step 1304), and returned to the caller (step 1306) with the process terminating thereafter.

With reference to FIG. 14, a flowchart of a process used to obtain a list of files is depicted in accordance with a preferred embodiment of the present invention. The processes illustrated in FIG. 14 may be implemented in an application, such as application 304 in FIG. 3.

The process begins by sending a call for a list of files (step 1400). This call includes a unique identifier as described above that is associated with an item. The call may be generated by an application in response to user input or may be an application generating a call for another application. This call is sent to a device driver, such as device driver 308 in FIG. 3. Next, a result is received (step 1402). Then, a list of categories or file names are presented on a display to the user (step 1404). A user selection is received (step 1406), and the selected files are returned to the appropriate applications (step 1408) with the process terminating thereafter. The user selection results in multiple files being selected, each of the files is sent to the application that has been associated with the file for use. For example, if a number of files are associated with a word processor, those files are sent to the word processor. If other files are associated with an image program, those files are sent to the image program. In any event, all of these files are associated with the same item through a unique identifier.

Thus, the present invention provides an improved method, apparatus, and computer instructions for allowing association of files with items. As described above in the illustrative examples of different embodiments of the present invention, an item may represent various things, such as an event, a customer, or a task. Each of these items are associated with a unique identifier in meta data in the manner described above. When a user saves a file that contains data, graphics, text, or a document, this association is specified by the user. The unique identifier is saved in a relational database, which may be queryed by the operating system or other applications used to back up, store, locate, or migrate data associated with the particular item.

For example, a user may specify that a document to be saved is associated with a particular customer as well as normal document storage information. The user may save the file and associate the document to ABC Corporation. Later, using the mechanism of the present invention, a program or operating system may query the database to show all files associated with ABC Corporation. Alternatively, other types of file manipulations, such as back up commands, may be performed using the unique identifiers of the present invention. For example, a command to back up all files associated with ABC Corporation may be made. Further, a particular file may be associated with more than one item. For example, a document may be associated with two items such that the same document is identified using either unique identifier.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

1. A method in a data processing system for locating files, the method comprising:
receiving an input indicating that a file is to be saved; and
responsive to receiving the input, saving the file in association with a unique identifier in a data store, wherein the data store describes associations between files and unique identifiers and wherein files are retrieved based on unique identifiers.

2. The method of claim 1 further comprising:
responsive to a request from a requester for files associated with the unique identifier, querying the data store for an identification of the files associated with the unique identifier.
receiving a result from the data store; and
returning the result to the requester.

3. The method of claim 1, wherein the result is presented as a list of categories to a user.

4. The method of claim 1, wherein the locations of the file are in a remote data processing system.

5. The method of claim 1, wherein input is a user input to save the file.

6. The method of claim 1, wherein the input is from a program initiating saving of the file.

7. The method of claim 1, wherein the identifier is selected from one of a user name, an event, or a task.

8. A file system comprising:
a data store, wherein the data store stores associations between files and unique identifiers; and
a file management process, wherein the file management process associates the unique identifier with the file in the data store when a file is saved and identifies files associated with a unique identifier in the data store when a query to retrieve files using the unique identifier is made.

9. A data processing system for locating files, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive an input indicating that a file is to be saved; and save the file in association with a unique identifier in a data store in response to receiving the input in which the data store describes associations between files and unique identifiers and in which files are retrieved based on unique identifiers.

10. A data processing system for locating files, the data processing system comprising:
receiving means for receiving an input indicating that a file is to be saved; and
saving means, responsive to receiving the input, for saving the file in association with a unique identifier in a data store, wherein the data store describes associations between files and unique identifiers and wherein files are retrieved based on unique identifiers.

11. The data processing system of claim 10 further comprising:
querying means, responsive to a request from a requester for files associated with the unique identifier, for querying the data store for an identification of the files associated with the unique identifier.
receiving means for receiving a result from the data store; and
returning means for returning the result to the requester.

12. The data processing system of claim 10, wherein the result is presented as a list of categories to a user.

13. The data processing system of claim 10, wherein the locations of the file are in a remote data processing system.

14. The data processing system of claim 10, wherein input is a user input to save the file.

15. The data processing system of claim 10, wherein the input is from a program initiating saving of the file.

16. The data processing system of claim 10, wherein the identifier is selected from one of a user name, an event, or a task.

17. A computer program product in a computer readable medium for locating files, the computer program product comprising:
first instructions for receiving an input indicating that a file is to be saved; and
second instructions, responsive to receiving the input, for saving the file in association with a unique identifier in a data store, wherein the data store describes associations between files and unique identifiers and wherein files are retrieved based on unique identifiers.

18. The computer program product of claim 17 further comprising:
third instructions, responsive to a request from a requester, for files associated with the unique identifier, querying the data store for an identification of the files associated with the unique identifier;
fourth instructions for receiving a result from the data store; and
fifth instructions for returning the result to the requester.

19. The computer program product of claim 17, wherein the result is presented as a list of categories to a user.

20. The computer program product of claim 17, wherein the locations of the file are in a remote data processing system.

21. The computer program product of claim 17, wherein input is a user input to save the file.

22. The computer program product of claim 17, wherein the input is from a program initiating saving of the file.

23. The computer program product of claim 17, wherein the identifier is selected from one of a user name, an event, or a task.
